(19) United States
(12) Patent Application Publication
(10) Pub. No.: US 2026/0153975 A1
(43) Pub. Date: Jun. 4, 2026

(54) MEDIA EDITING

(71) Applicant: Beijing Zitiao Network Technology Co., Ltd., Beijing (CN)

(72) Inventors: Jiayu JI, Beijing (CN); Xinyu Zhang, Beijing (CN)

(21) Appl. No.: 19/406,868

(22) Filed: Dec. 2, 2025

(30) Foreign Application Priority Data
Dec. 3, 2024 (WO) PCT/CN2024/136580

(51) Int. Cl. G06F 3/0484; G06F 3/0482; G06F 40/106; G06F 40/186

(52) U.S. Cl. CPC G06F 3/0484; G06F 3/0482; G06F 40/106; G06F 40/186

(57) ABSTRACT

Embodiments of the disclosure relates to a method, an apparatus, a device, and a storage medium of media editing. The method proposed herein includes: presenting caption content in an editing interface of media content; presenting, in a first style, a set of content segments associated with the caption content in an editing interface in response to a first operation received in the editing interface, the set of content segments corresponding to a target type to be filtered, the target type being determined based on a type configuration control in the editing interface; and editing the caption content of the media content based on the set of content segments.

### CROSS-REFERENCE

This application claims priority to International Patent Application No. PCT/CN2024/136580, filed on Dec. 3, 2024, and entitled “METHOD, APPARATUS, DEVICE, AND STORAGE MEDIUM FOR MEDIA EDITING”, which is incorporated herein by reference in its entirety.

### FIELD

Example embodiments of the present disclosure generally relate to the field of computers, and in particular, to media editing.

### BACKGROUND

In recent years, with the development of the Internet, more and more users perform interactive activities on a network platform, for example, posting or browsing media content on a network platform. When posting media content in a traditional network platform, a user needs to edit media content. However, in the process of editing media content by the user, how to improve the processing efficiency of caption content is still an important problem faced by users and platforms.

### SUMMARY

In a first aspect of the present disclosure, a method of media editing is provided, including: presenting caption content in an editing interface of media content; presenting, in a first style, a set of content segments associated with the caption content in the editing interface in response to a first operation received in an editing interface, the set of content segments corresponding to a target type to be filtered, the target type being determined based on a type configuration control in the editing interface; and editing the caption content of the media content based on the set of content segments.

In a second aspect of the present disclosure, an apparatus for media editing is provided. The apparatus includes: a first presenting module configured to present caption content in an editing interface of media content; a second presenting module configured to present, in a first style, a set of content segments in the caption content in an editing interface in response to a first operation received in the editing interface, the set of content segments corresponding to a target type to be filtered, the target type determined based on a type configuration control in the editing interface; and an editing module configured to edit caption content of the media content based on the set of content segments.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium has a computer program stored thereon, and the computer program is executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will be readily understood from the following description.

### BRIEF DESCRIPTION OF DRAWINGS

The above and other features, advantages, and aspects of various embodiments of the present disclosure will become more apparent with reference to the following detailed description taken in conjunction with the accompanying drawings. Throughout the drawings, the same or similar reference signs denote the same or similar elements, where:

FIG. 1 illustrates a schematic diagram of an example environment in which the some embodiments of the present disclosure can be implemented;

FIG. 2A to FIG. 2F illustrate example interfaces according to some embodiments of the present disclosure;

FIG. 3 illustrates a flowchart of an example process of editing media according to some embodiments of the present disclosure;

FIG. 4 illustrates a schematic structural block diagram of an example apparatus for editing media according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be implemented in various forms, and should not be construed as being limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the heading of any section/subsection provided in this article is not limiting. Various embodiments are described throughout herein, and any type of embodiments may be included in any section/subsection. Furthermore, embodiments described in any section/subsection may be combined in any way with any other embodiments in the same section/subsection and/or any other embodiment described in different sections/subsections.

In the description of embodiments of the present disclosure, the terms “including” and similar expressions should be understood as an open-ended inclusion, this is, “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or the same objects. Other explicit and implicit definitions may also be included below.

Embodiments of the present disclosure may relate to data of a user, acquisition and/or use of data, and the like. These aspects all comply with corresponding laws, regulations and relevant regulations. In the embodiments of the present disclosure, collection, obtaining, processing, processing, interaction, use, etc. of all data, are performed with the user's knowledge and confirmation. Accordingly, when implementing each embodiment of the present disclosure, users should be informed of the type, scope of use, usage scenarios, etc. that may be involved in the data or information and obtain their authorization through appropriate means in accordance with relevant laws and regulations. The specific notification and/or authorization methods may vary according to actual situations and application scenarios, and the scope of the present disclosure is not limited in this respect.

In the solutions in the present specification and the embodiments, if the processing of personal information is involved, the processing will be carried out on the premise of a legal basis (for example, obtaining consent from the data subject or necessity to fulfill a contract), and the processing will be carried out within the scope of the stipulations or agreements. The user's refusing to process any personal information beyond what is necessary for the basic functions will not affect their use of those functions.

As briefly mentioned above, with the development of the Internet, more and more users perform interactive activities on a network platform, for example, posting or browsing media content on a network platform. When posting media content in a traditional network platform, a user needs to edit media content. However, in the process of editing media content by the user, how to improve the processing efficiency of caption content is still an important problem faced by users and platforms. For example, a traditional network platform cannot provide a convenient way to filter caption content, thereby failing to meet the needs of users.

Embodiments of the present disclosure provide a solution for editing media. According to the solution, caption content may be presented in an editing interface of media content. In response to a first operation received in the editing interface, a set of content segments in the caption content is presented in a first style in the editing interface. The set of content segments corresponds to a target type to be filtered, and the target type is determined based on a type configuration control in the editing interface. The caption content of the media content is edited based on the set of content segments.

In this way, embodiments of the present disclosure may present caption content in an editing interface of media content, and can present a set of content segments to be filtered of the caption content in a predetermined style based on the received operation. In addition, embodiments of the present disclosure may further determine a target type corresponding to a set of content segments to be filtered based on a type configuration control in the editing interface. In this way, embodiments of the present disclosure can support the user to filter the caption content based on the type of configuration, thereby improving efficiency of the user filtering the caption content and editing the media content.

Various example implementations of this solution are described in detail below with reference to the accompanying drawings.

### Example Environment

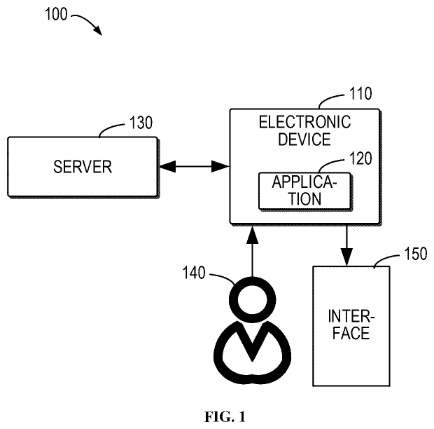

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: a video application, a social application, or other suitable application. The user 140 may interact with the application 120 via the electronic device 110 and/or attached device thereof.

In the environment 100 of FIG. 1, if the application 120 is active, the electronic device 110 may present an interface 150 for supporting interface interaction through the application 120.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game console, a virtual reality/augmented reality (VR/AR) device, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination of the foregoing, including accessories and peripherals of these devices, or any combination thereof. In some embodiments, the electronic device 110 can also support any type of interface for a user (such as a “wearable” circuit, etc.) .

The server 130 may be a standalone physical server, or may be a server cluster or a distributed system that includes a plurality of physical servers, or may be a cloud server that provides basic cloud computing services such as cloud service, cloud database, cloud computing, cloud function, cloud storage, network service, cloud communication, middleware service, domain name service, security service, content distribution network, big data and artificial intelligence platform, and so on. The server 130 may include, for example, a computing system/server, such as a mainframe, an edge computing node, a computing device in a cloud environment, and the like. The server 130 may provide a background service for the application 120 in the electronic device 110 that supports interface interaction.

A communication connection may be established between the server 130 and the electronic device 110. The communication connection may be established via a wired or wireless manner. The communication connection may include, but is not limited to, a Bluetooth connection, a mobile network connection, a universal serial bus (USB) connection, a wireless fidelity (Wi-Fi) connection, and so on. Embodiments of the present disclosure are not limited in this aspect. In the of the present disclosure, the server 130 and the electronic device 110 may implement signaling interaction through a communication connection in between.

It should be understood that the structures and functions of various elements in the environment 100 are described for illustrative purposes only and do not imply any limitation to the scope of the present disclosure.

Some example embodiments of the present disclosure will continue to be described below with reference to the accompanying drawings.

### Example Interaction

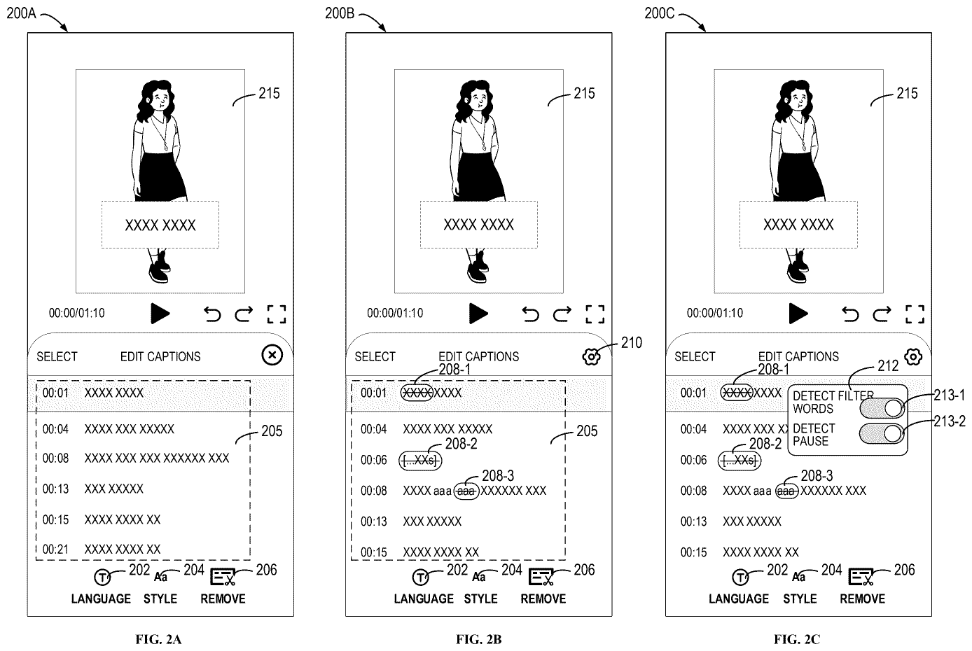

FIG. 2A to FIG. 2F illustrate example interfaces 200A to 200F according to some embodiments of the present disclosure. The interface 200A to the interface 200F may be provided, for example, by the electronic device 110 shown in FIG. 1.

In some embodiments, as shown in FIG. 2A, the electronic device 110 may present an editing interface 200A of the media content. As an example, the media content may include, for example, video content, audio content, graphics and text content, and the like. For example, the electronic device 110 may edit the media content in the editing interface to alter image content, text content, and/or audio content, and the like of the media content. The present disclosure is illustratively described by taking the editing process of the caption content of the media content as an example.

In some embodiments, the electronic device 110 may present caption content 205 corresponding to the media content in the editing interface 200A. As an example, the caption content 205 may be generated based on the media content with a predetermined model. As an example, the predetermined model may be a generative model with speech recognition capability. The present disclosure is not intended to limit the specific implementation of the generative model. As an example, before generating the caption 205, the electronic device 110 may determine a language associated with the media content. Furthermore, the electronic device 110 may generate the caption content 205 with a predetermined model based on a language associated with the media content.

Alternatively, the electronic device 110 may determine, in response to a language associated with the media content being a predetermined language (for example, English), a content segment (for example, a logogram, a mark text, a pause, and the like) to be filtered in the caption content 205 by using a language model. As an example, the predetermined model may be a generative model with text content to be filtered based on text. The present disclosure is not intended to limit the specific implementation of the generative model.

As an example, the electronic device 110 may provide the language control 202 in the editing interface 200A. Further, the electronic device 110 may present a set of candidate languages (e.g., Chinese, English, French, and so on) in response to receiving the selection of the language control 202. Moreover, the electronic device 110 may present the caption content 205 based on the target language in response to selection of the target language in the set of candidate languages.

Additionally, or alternatively, the electronic device 110 may provide the preview area 215 in the editing interface 200A. The electronic device 110 may present a preview image of the media content in the preview area 215. The electronic device 110 may present caption elements associated with the caption content in the preview area 215. As an example, the caption content 205 may include a plurality of pieces of text content. As an example, the electronic device 110 may present, in the preview area 215, a preview image and a caption element associated with the target text content in response to a selection of target text content in the plurality of pieces of text content.

Additionally, or alternatively, the electronic device 110 may present time information corresponding to the caption content 205 in the editing interface 200A. As an example, the electronic device 110 may present, in the editing interface 200A, a plurality of moments corresponding to the plurality of pieces of text content.

As an example, the electronic device 110 may present, in the editing interface 200A, a set of content segments associated with the caption content 205 in a first style in response to a first operation received in the editing interface. For example, the electronic device 110 may present the removal control 206 in the editing interface 200A. Further, the electronic device 110 may present, in the editing interface 200A, a set of content segments associated with the caption content 205 in a first style in response to a trigger for the removal control 206. As an example, the electronic device 110 may, in response to a trigger for the removal control 206, jump to the content segment that is presented at the first position in the set of content segments (for example, the content segment determined to be in time based on the time information) in the editing interface 200A.

Alternatively, in response to a set of content segments associated with the caption content 205 being presented in the first style the editing interface 200A, the electronic device 110 may, upon initiating the preview playback, cause the preview area 215 to stop presenting the preview image and the caption element associated with the set of content segments in the media content. (That is, the electronic device 110 may skip segments of media content associated with a set of content segments while playing the preview).

In some embodiments, as shown in FIG. 2B, the electronic device 110 may present, in the first style, a set of content segments associated with the caption content 205 in the editing interface 200B. As an example, the first style is used to highlight the set of content segments in the caption content 205 to indicate that the set of content segments are marked as content segments to be filtered. As an example, the electronic device 110 presenting the set of content segments in the first style may include using an indication element (e.g., an indication box) to drag-select the set of content segments, display the set of content segments in bold, highlight the set of content segments, and/or drawing lines on the set of content segments, and so on. For example, the set of content segments may include content 208-1, content 208-2, and content 208-3, and so on.

Additionally, or alternatively, the set of content segments corresponds to a target type to be filtered. For example, the target type is determined based on a type configuration control in the editing interface 200A.

As an example, the electronic device 110 may provide the type configuration entry 210 in the editing interface 200B. Further, the electronic device 110 may present the type configuration control in the editing interface 200B in response to a trigger for the type configuration entry 210.

In some embodiments, as shown in FIG. 2C, the electronic device 110 may present the type configuration control 212 in the editing interface 200C. The type configuration control 212 may include a plurality of type options corresponding to a plurality of candidate types. As an example, the plurality of type options may include a type option 213-1 (e.g., detect filter words) and a type option 213-2 (e.g., detect pause).

For example, the plurality of candidate types may include a first type. The first type may indicate that semantic information of the corresponding content satisfies a first condition. As an example, the semantic information meeting the first condition may indicate a semantic repetition of the content segment. For example, the content 208-3 may correspond to the first type (e.g., the “aaa” presented in a first style is repetitive with the preceding “aaa” content). As an example, the semantic information meeting the first condition may further indicate that a semantic corresponding to the content segment is an interjection (e.g., um, hmm, emm, eh, ah, and so on).

Additionally or alternatively, the plurality of candidate types may include a second type. The second type may indicate that the corresponding content matches the predetermined keyword. For example, the predetermined keyword may include a discourse marker (e.g., well, you know, what I mean is, or, and the like) and/or an interjection. For example, the content 208-1 may correspond to the second type.

Additionally, the plurality of candidate types may include a third type. The third type may indicate that an audio parameter of the corresponding content meets a second condition. As an example, the content 208-2 may correspond to the third type. For example, the content 208-2 may correspond to a silence segment (e.g., a non-vocal segment or a pause segment) in the media content. As an example, the electronic device 110 may present a silence duration (e.g., XXs) in the content 208-2. As an example, the audio parameter of the content 208-2 meeting the second condition may include, for example, a silence segment of the content 208-2 exceeding a predetermined duration (e.g., 500 milliseconds, etc.).

As an example, the type option 213-1 may correspond to the first type and/or the second type. The type option 213-2 may correspond to the third type. As an example, the electronic device 110 may determine a configuration state of the type configuration control 212 based on whether a plurality of type options is selected. Moreover, the electronic device 110 may determine the target type to be filtered based on the configuration state of the type configuration control 212. As an example, the electronic device 110 may determine that the target type to be filtered includes the first type and/or the second type in response to the type option 213-1 being selected. As an example, the electronic device 110 may determine that the target type to be filtered includes the third type in response to the type option 213-2 being selected.

Additionally, or alternatively, the electronic device 110 may determine a predetermined configuration state of the type configuration control 212 in response to not receiving a selection operation of the user on the plurality of types of options. As an example, the predetermined configuration state of the type configuration control 212 may include, for example, that a plurality of types of options is all in a selected state.

Additionally, the electronic device 110 may delete the content segment associated with the target type option from the set of content segments in response to the user deselecting the target type option of the plurality of type options. As an example, the electronic device 110 may delete the content segment (e.g., the content 208-2) associated with the type option 213-2 from the set of content segments in response to the user canceling the selection of the type option 213-2. For example, the electronic device 110 may adjust the presentation style of the content 208 from the first style to the second style to indicate that the content 208-2 is no longer filtered.

As an example, the electronic device 110 may edit the caption content of the media content based on a set of content segments. As an example, as shown in FIG. 2C, the electronic device 110 may remove the set of content segments from the caption content in response to a predetermined operation (for example, a trigger (for example, a click operation) on the removal control 206).

As an example, the electronic device 110 may determine at least one target segment to be filtered of the set of content segments based on the second operation received in the editing interface 200C. For example, the set of content segments may include the content 208-1, the content 208-2, and the content 208-3. The electronic device 110 may receive a selection of a target content segment of the set of content segments. Furthermore, the electronic device 110 may update the target content segment to the second style based on the selection of the target content segment to indicate that the target content segment is unmarked as the content segment to be filtered. As an example, the electronic device 110 may remove the target content segment from the set of content segments based on the selection of the target content segment. As an example, the second style may be different from the first style to indicate that the target content segment is unmarked as the content segment to be filtered.

For example, the electronic device 110 may update the content 208-1 to the second style and remove the content 208-1 from the set of content segments in response to a selection of the content 208-1 (e.g., a click operation). Further, the electronic device 110 may determine that the at least one target segment is the content 208-2 and content 208-3. Furthermore, the electronic device 110 may remove the at least one target segment from the caption content in response to a predetermined operation (for example, a trigger (such as, a click operation) on the removal control 206).

Additionally, or alternatively, the electronic device 110 may delete a part of the media content corresponding to the at least one target segment (that is, the media content and the caption element corresponding to the at least one target segment) in response to a predetermined operation (for example, a trigger (such as, a click operation) on the removal control 206).

Additionally, or alternatively, the electronic device 110 may, in response to removing the at least one target segment from the caption content, re-determine caption content corresponding to the media content based on the predetermined model mentioned above.

In some embodiments, with continued reference to FIG. 2A, the electronic device 110 may present a set of style templates in the editing interface 200A in response to receiving the third operation in the editing interface 200A.

As an example, the electronic device 110 may provide the style control 204 in the editing interface 200A. Further, the electronic device 110 may present the set of style templates in the editing interface 200A in response to a trigger of the style control 204.

In some embodiments, as shown in FIG. 2D, the electronic device 110 may present a set of style templates 220 in the editing interface 200D. Further, the electronic device 110 may apply a target style template to at least part of the caption content in response to the selection of the target style template of the set of style templates.

As an example, the caption content may include a plurality of pieces of text content. The electronic device 110 may receive a selection of target text content of the plurality of pieces of text content. Further, the electronic device 110 may present the target text content and the set of style templates in the editing interface in response to receiving the third operation in the editing interface. Furthermore, the electronic device 110 may apply the target style template to the target text content in response to the selection of the target style template of the set of style templates. As an example, the electronic device 110 may also provide a selection control (e.g., all selection controls) in the editing interface. The electronic device 110 may apply the target style template to the caption content (e.g., all caption content) in response to the selection of the target style template of the set of style templates and the selection control being in the selected state.

Alternatively, the electronic device 110 may present, in response to receiving the third operation, the set of style templates in the editing interface before receiving the selection of the plurality of pieces of text content. Moreover, the electronic device 110 may apply the target style template to the caption content (for example, all caption content) in response to the selection of the target style template of the set of style templates.

As an example, the target style template may include one or more of a font template (e.g., font size, font), a caption animation template (e.g., caption presenting animation and caption vanishing animation and so on), and a text style template (e.g., text color, text background, text arrangement manner and so no). Thus, based on embodiments of the present disclosure, the electronic device 110 may apply one or more styles to at least part of the caption content based on the target style template.

Additionally, or alternatively, the electronic device 110 may adjust at least one of a font, a caption animation, or a text style of at least part of the caption content based on an editing operation of the user.

In some embodiments, the caption content 205 may include a plurality of pieces of text content. As shown in FIG. 2E, the electronic device 110 may receive a selection of target text content of a plurality of pieces of text content. The input panel 222 is presented in the editing interface 200E to receive an editing operation of the user on the target text content. In this way, embodiments of the present disclosure may support separately adjusting each piece of text content within the caption content 205.

In some embodiments, as shown in FIG. 2F, the electronic device 110 may present the deletion control 224 in response to selection of at least one piece of text content of the plurality of pieces of text content. Further, the electronic device 110 may delete the at least one piece of text content from the plurality of pieces of text content in response to a trigger (for example, a click operation) on the deletion control 224.

Based on the process described above, in this way, embodiments of the present disclosure can present caption content in an editing interface of media content, and can present, based on the received operation, a set of content segments to be filtered of the caption content in a predetermined style. In addition, embodiments of the present disclosure may further determine a target type corresponding to a set of content segments to be filtered based on a type configuration control in the editing interface. In this way, embodiments of the present disclosure can support the user to filter the caption content based on the type of configuration, thereby improving the efficiency of the user filtering the caption content and editing the media content.

### Example Processes

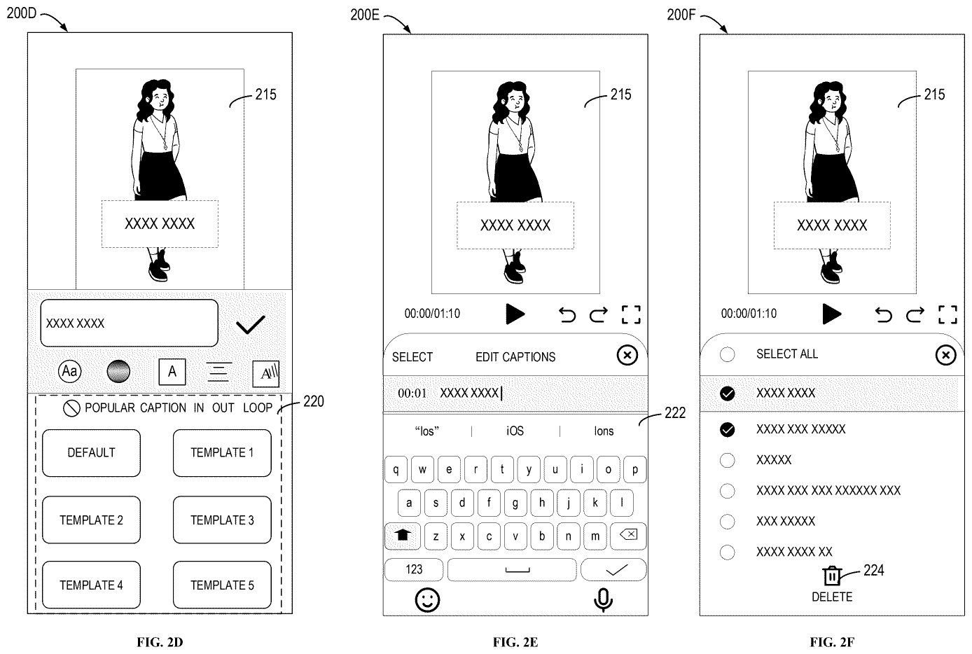

FIG. 3 illustrates a flowchart of an example process 300 of editing media according to some embodiments of the present disclosure. The process 300 may be implemented at electronic device 110. The process 300 is described below with reference to FIG. 1.

As shown in FIG. 3, at block 310, the electronic device 110 presents caption content in an editing interface of media content.

At block 320, the electronic device 110 presents, in a first style, a set of content segments associated with the caption content in the editing interface in response to a first operation received in the editing interface, the set of content segments corresponding to a target type to be filtered, the target type being determined based on a type configuration control in the editing interface.

At block 330, the electronic device 110 edits the caption content of the media content based on the set of content segments.

In some embodiments, editing the caption content of the media content based on the set of content segments includes: determining at least one target segment to be filtered of the set of content segments based on a second operation received in the editing interface; and removing the at least one target segment from the caption content.

In some embodiments, the process 300 further includes deleting a part of the media content corresponding to the at least one target segment.

In some embodiments, determining the at least one target segment to be filtered of the set of content segments based on the second operation received in the editing interface includes: receiving a selection of a target content segment of the set of content segments; and updating the target content segment to a second style based on the selection to indicate that the target content segment is unmarked as the content segment to be filtered.

In some embodiments, the process 300 further includes: presenting the type configuration control in the editing interface; and determining a target type to be filtered based on a configuration state of the type configuration control.

In some embodiments, the type configuration control includes a plurality of type options corresponding to the plurality of candidate types, and the configuration state indicates whether the plurality of type options are selected.

In some embodiments, the plurality of candidate types includes at least one of the following: a first type indicating that semantic information of a corresponding content meets the first condition; a second type indicating that the corresponding content matches a predetermined keyword; and a third type indicating that an audio parameter of the corresponding content meets a second condition.

In some embodiments, the process 300 further includes: presenting a set of style templates in the editing interface in response to a third operation received in the editing interface; and applying a target style template to at least a part of the caption content in response to a selection of the target style template of the set of style templates.

In some embodiments, the editing interface further includes a preview area, and the process 300 further includes: presenting a preview image of the media content and a caption element associated with the caption content in the preview area.

### Example Apparatus and Device

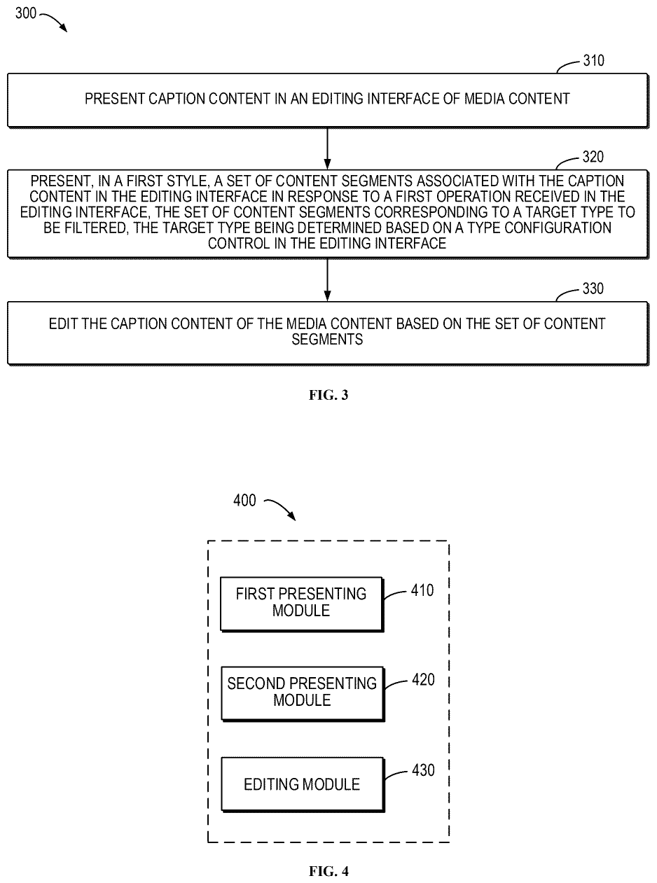

Embodiments of the present disclosure also provide a corresponding apparatus for implementing the above method or process. FIG. 4 illustrates a schematic structural block diagram of an example apparatus 400 for editing media according to some embodiments of the present disclosure. The apparatus 400 may be implemented or included in an electronic device. The various modules/components in the apparatus 400 may be implemented by hardware, software, firmware, or any combination thereof.

As shown in FIG. 4, the apparatus 400 includes a first presenting module 410 configured to present caption content in an editing interface of the media content; a second presenting module 420 configured to present, in a first style, a set of content segments associated with the caption content in the editing interface in response to a first operation received in the editing interface, the set of content segments corresponding to a target type to be filtered, the target type being determined based on a type configuration control in the editing interface; and an editing module 430 configured to edit the caption content of the media content based on the set of content segments.

In some embodiments, the editing module 430 is further configured to: determine at least one target segment to be filtered of the set of content segments based on the second operation received in the editing interface; and remove the at least one target segment from the caption content.

In some embodiments, the apparatus 400 further includes a deletion module further configured to delete a part of the media content corresponding to the at least one target segment.

In some embodiments, the editing module 430 is further configured to: receive a selection of a target content segment of the set of content segments; and update the target content segment to a second style based on the selection to indicate that the target content segment is unmarked as the content segment to be filtered.

In some embodiments, the apparatus 400 further includes a determining module configured to: present a type configuration control in the editing interface; and determine a target type to be filtered based on the configuration state of the type configuration control.

In some embodiments, the type configuration control includes a plurality of type options corresponding to the plurality of candidate types, and the configuration state indicates whether the plurality of type options are selected.

In some embodiments, the plurality of candidate types includes at least one of the following: a first type indicating that semantic information of a corresponding content meets the first condition; a second type indicating that the corresponding content matches a predetermined keyword; and a third type indicating that an audio parameter of a corresponding content meets the second condition.

In some embodiments, the apparatus 400 further includes a style module configured to: present a set of style templates in the editing interface in response to a third operation received in the editing interface; and apply a target style template to at least a part of the caption content in response to a selection of the target style template of the set of style templates.

In some embodiments, the editing interface further includes a preview area, and the apparatus 400 further includes a preview module configured to: present a preview image of the media content and a caption element associated with the caption content in the preview area.

The units included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the elements in the apparatus 400 may be implemented, at least in part, by one or more hardware logic components. By way of example and not limitation, example types of hardware logic components that may be used include a field programmable gate array (FPGA), an application specific integrated circuit (ASIC), an application specific standard (ASSP), a system-on-a-chip (SOC), a complex programmable logic device (CPLD), and the like.

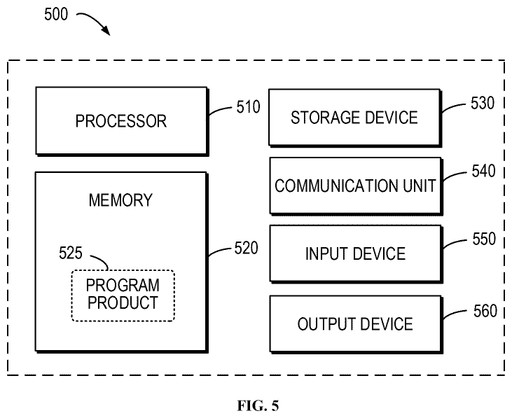

FIG. 5 illustrates a block diagram of an electronic device 500 in which one or more embodiments of the present disclosure may be implemented. It should be appreciated that the electronic device 500 illustrated in FIG. 5 is merely illustrative and should not constitute any limitation on the functionality and scope of the embodiments described herein. The electronic device 500 shown in FIG. 5 may be used in an electronic device.

As shown in FIG. 5, the electronic device 500 is in the form of a general-purpose electronic device. Components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processors execute computer-executable instructions in parallel to improve parallel processing capabilities of electronic device 500.

The electronic device 500 typically includes a plurality of computer storage media. Such media may be any available media accessible to the electronic device 500, including, but not limited to, volatile and non-volatile media, removable and non-removable media. The memory 520 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 530 may be a removable or non-removable medium and may include a machine-readable medium, such as a flash drive, magnetic disk, or any other medium, which may be used to store information and/or data and may be accessed within electronic device 500.

The electronic device 500 may further include additional removable/non-removable, volatile/non-volatile storage media. Although not shown in FIG. 5, a disk drive for reading or writing from a removable, non-volatile magnetic disk (e.g., a “floppy disk”) and an optical disk drive for reading or writing from a removable, non-volatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device over a communication medium. Additionally, the functionality of components of the electronic device 500 may be implemented in a single computing cluster or a plurality of computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/actions specified in one or more blocks of the flowchart and/or block diagram(s).

The computer-readable program instructions may be loaded onto a computer, other programmable data processing apparatus, or other apparatus, causing a series of operational steps to be performed on a computer, other programmable data processing apparatus, or other apparatus to produce a computer-implemented process such that the instructions, when executed on a computer, other programmable data processing apparatus, or other devices implement the functions/acts specified in the flowchart and/or block diagram.

The flowchart and block diagrams in the drawings show architecture, functionality, and operation of possible implementations of systems, methods, and computer program products according to various implementations of the present disclosure. In this regard, each block in the flowchart or block diagram may represent a module, a program segment, or a portion of an instruction that includes one or more executable instructions for implementing the specified logical function. In some alternative implementations, the functions marked in the blocks may also occur in a different order than marked in the drawings. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented using a combination of dedicated hardware and computer instructions.

Various implementations of the present disclosure have been described above, and the foregoing description is illustrative, not exhaustive, and is not limited to the implementations as disclosed. Many modifications and variations will be apparent to those of ordinary skill in the art without departing from the scope and spirit of the illustrated implementations. The terminology used herein has been chosen to best explain the principles of the implementations, practical applications, or improvements to techniques in the marketplace, or to enable those skilled in the art to understand the various implementations disclosed herein.

1. A method of media editing, comprising:
presenting caption content in an editing interface of media content;
presenting, in a first style, a set of content segments associated with the caption content in the editing interface in response to a first operation received in the editing interface, the set of content segments corresponding to a target type to be filtered, the target type being determined based on a type configuration control in the editing interface; and
editing the caption content of the media content based on the set of content segments.

2. The method of claim 1, wherein editing the caption content of the media content based on the set of content segments comprises:
determining at least one target segment to be filtered of the set of content segments based on a second operation received in the editing interface; and
removing the at least one target segment from the caption content.

3. The method of claim 2, further comprising:
deleting a part of the media content corresponding to the at least one target segment.

4. The method of claim 2, wherein determining at least one target segment to be filtered of the set of content segments based on a second operation received in the editing interface comprises:
receiving a selection of a target content segment of the set of content segments; and
updating the target content segment to a second style based on the selection to indicate that the target content segment is unmarked as a content segment to be filtered.

5. The method of claim 1, further comprising:
presenting the type configuration control in the editing interface; and
determining the target type to be filtered based on a configuration state of the type configuration control.

6. The method of claim 5, wherein the type configuration control comprises a plurality of type options corresponding to a plurality of candidate types, and the configuration state indicates whether the plurality of type options are selected.

7. The method of claim 6, wherein the plurality of candidate types comprises at least one of the following:
a first type indicating that semantic information of a corresponding content meets a first condition;
a second type indicating that a corresponding content matches a predetermined keyword; or
a third type indicating that a audio parameter of a corresponding content meets a second condition.

8. The method of claim 1, further comprising:
presenting a set of style templates in the editing interface in response to a third operation received in the editing interface; and
applying a target style template to at least part of the caption content in response to a selection of the target style template of the set of style templates.

9. The method of claim 1, wherein the editing interface further comprises a preview area, the method further comprising:
presenting a preview image of the media content and a caption element associated with the caption content in the preview area.

10. An electronic device comprising:
at least one processor; and
at least one memory coupled to the at least one processor and storing instructions for execution by the at least one processor, the instructions, when executed by the at least one processor, causing the electronic device to perform acts comprising:
presenting caption content in an editing interface of media content;
presenting, in a first style, a set of content segments associated with the caption content in the editing interface in response to a first operation received in the editing interface, the set of content segments corresponding to a target type to be filtered, the target type being determined based on a type configuration control in the editing interface; and
editing the caption content of the media content based on the set of content segments.

11. The electronic device of claim 10, wherein editing the caption content of the media content based on the set of content segments comprises:
determining at least one target segment to be filtered of the set of content segments based on a second operation received in the editing interface; and
removing the at least one target segment from the caption content.

12. The electronic device of claim 11, wherein the acts further comprise:
deleting a part of the media content corresponding to the at least one target segment.

13. The electronic device of claim 11, wherein determining at least one target segment to be filtered of the set of content segments based on a second operation received in the editing interface comprises:
receiving a selection of a target content segment of the set of content segments; and
updating the target content segment to a second style based on the selection to indicate that the target content segment is unmarked as a content segment to be filtered.

14. The electronic device of claim 10, wherein the acts further comprise:
presenting the type configuration control in the editing interface; and
determining the target type to be filtered based on a configuration state of the type configuration control.

15. The electronic device of claim 14, wherein the type configuration control comprises a plurality of type options corresponding to a plurality of candidate types, and the configuration state indicates whether the plurality of type options are selected.

16. The electronic device of claim 15, wherein the plurality of candidate types comprises at least one of the following:
a first type indicating that semantic information of a corresponding content meets a first condition;
a second type indicating that a corresponding content matches a predetermined keyword; or
a third type indicating that a audio parameter of a corresponding content meets a second condition.

17. The electronic device of claim 10, wherein the acts further comprise:
presenting a set of style templates in the editing interface in response to a third operation received in the editing interface; and
applying a target style template to at least part of the caption content in response to a selection of the target style template of the set of style templates.

18. The electronic device of claim 10, wherein the editing interface further comprises a preview area, the method further comprising:
presenting a preview image of the media content and a caption element associated with the caption content in the preview area.

19. A non-transitory computer-readable storage medium having a computer program stored thereon, wherein the computer program is executable by a processor to implement acts comprising:
presenting caption content in an editing interface of media content;
presenting, in a first style, a set of content segments associated with the caption content in the editing interface in response to a first operation received in the editing interface, the set of content segments corresponding to a target type to be filtered, the target type being determined based on a type configuration control in the editing interface; and
editing the caption content of the media content based on the set of content segments.

20. The non-transitory computer-readable storage medium of claim 19, wherein editing the caption content of the media content based on the set of content segments comprises:
determining at least one target segment to be filtered of the set of content segments based on a second operation received in the editing interface; and
removing the at least one target segment from the caption content.
